(19) United States
(12) Patent Application Publication
(10) Pub. No.: US 2021/0122852 A1
(43) Pub. Date: Apr. 29, 2021

(54) END-MODIFIED DIENE POLYMER, AND METHOD FOR PRODUCING THE POLYMER

(71) Applicant: Toyo Tire Corporation, Itami-shi (JP)

(72) Inventor: Taiki Iwachi, Itami-shi (JP)

(73) Assignee: Toyo Tire Corporation, Itami-shi (JP)

(21) Appl. No.: 17/063,871

(22) Filed: Oct. 6, 2020

(30) Foreign Application Priority Data
Oct. 24, 2019 (JP) 2019-193649

(51) Int. Cl. C08F 136/14

(52) U.S. Cl. CPC C08F 136/14

(57) ABSTRACT

An end-modified diene polymer having excellent mechanical properties and a method for producing the polymer are provided. An end-modified diene polymer having at least one of the structures represented by the following formulae (1) to (4) at the end thereof:

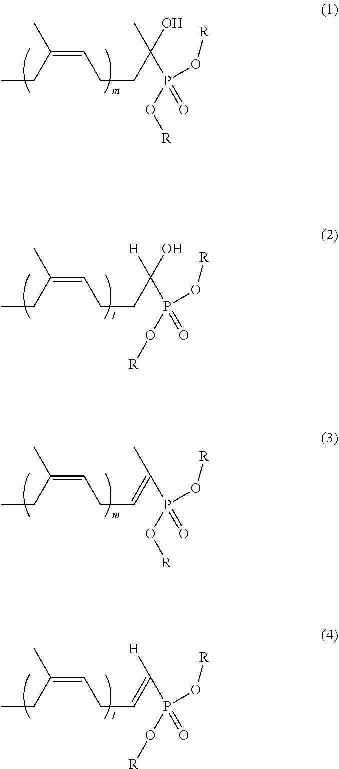

wherein Rs which may be the same or different each represent a hydrogen atom or a hydrocarbon group having 1 to 12 carbon atoms, and m and l which may be the same or different, respectively, each represent an integer of 2 or more.

### TECHNICAL FIELD

The present invention relates to an end-modified diene polymer and a method for producing the polymer.

### BACKGROUND ART

Various means for enhancing properties of a rubber polymer are conventionally investigated. For example, Patent Literature 1 describes a method for producing a modified polymer, comprising reacting a compound represented by the formula (M) with a polymer having at least one carbon-carbon double bond, wherein a manganese catalyst having an acetylacetonate ligand is used in reacting the compound with the polymer.

Patent Literature 2 describes a method for preparing a polymer, including metallizing an organophosphine compound in the substantial absence of a monomer to form a metallized organophosphine, and introducing the metallized organophosphine into a monomer containing a conjugated diene to form a reactive polymer.

Patent Literature 3 describes a rubber composition comprising (A) a conjugated diene rubber having a group having an active hydrogen and a group capable of chemically bonding to silica, obtained by polymerizing a conjugated diene compound or polymerizing a conjugated diene compound and an aromatic vinyl compound, (B) silica, (C) a silane coupling agent (I) capable of reacting with a carbon-carbon double bond of the conjugated diene in the conjugated diene rubber, and (D) a silane coupling agent (II) capable of reacting with the group having an active hydrogen, and a method for producing a rubber composition, comprising mixing the rubber composition.

Patent Literature 4 describes a method for producing a modified natural rubber, including a storing step of storing a natural rubber latex at a pH of 10.0 or larger and at 50° C. for 1 hour or more, a chemical treatment step of subjecting the stored natural rubber latex to a chemical treatment, and a coagulating and drying step of coagulating and drying the natural rubber latex having been subjected to the chemical treatment.

However, further improvement has been required in the enhancement of mechanical properties of the diene rubber.
Patent Literature 1: JP-A2017-31370
Patent Literature 2: JP-T 2015-512461 (the term “JP-T” as used herein means a published Japanese translation of a PCT patent application)
Patent Literature 3: WO2012/032895
Patent Literature 4: JP-A 2013-147555

### SUMMARY OF INVENTION

In view of the above circumstances, an object of the present invention is to provide an end-modified diene polymer having excellent mechanical properties. Another object of the present invention is to provide a method for producing the end-modified diene rubber.

### DESCRIPTION OF EMBODIMENTS

To overcome the above-described problems, the end-modified diene polymer according to the present invention has at least one of the structures represented by the following formulae (1) to (4) at the end thereof:

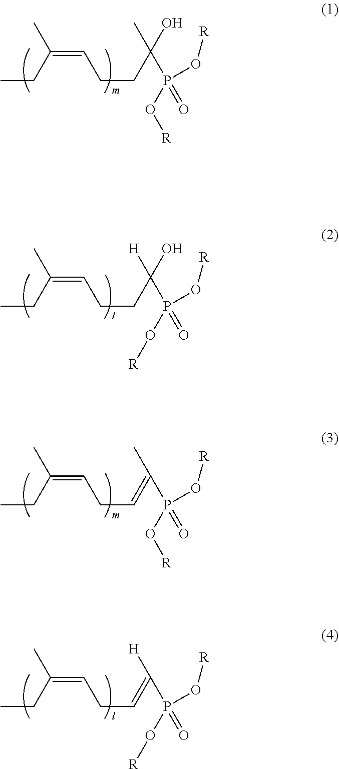

In the formulae (1) to (4), Rs which may be the same or different each represent a hydrogen atom or a hydrocarbon group having 1 to 12 carbon atoms, and m in and l which may be the same or different, respectively, each represent an integer of 2 or more.

The end-modified diene polymer can have a molecular weight of 400,000 to 4,000,000.

The method for producing an end-modified diene polymer according to the present invention includes an oxidative decomposition step of adding an oxidizing agent to a diene polymer to oxidatively cleave a carbon-carbon double bond, thereby obtaining an oxidatively decomposed diene polymer, and an end modification step of adding phosphites represented by the formula (5) to the oxidatively decomposed diene polymer obtained and conducting a reaction.

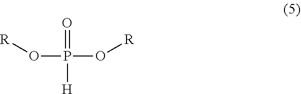

In the formula (5), R represents a hydrogen atom or a hydrocarbon group having 1 to 12 carbon atoms, and two Rs may be the same or different.

The amount of the phosphites added is 0.05 to 1.0 mol per 1 kg of the diene polymer.

The diene polymer can be used in the form of a rubber latex.

The oxidative decomposition step and the end modification step can be conducted in one pot.

According to the present invention, an end-modified diene polymer having excellent mechanical properties and a method for producing the polymer can be provided.

### DESCRIPTION OF EMBODIMENTS

The elements for carrying out the present invention are described in detail below.

The end-modified diene polymer according to the present invention has at least one of the structures represented by the following formulae (1) to (4) at the end thereof.

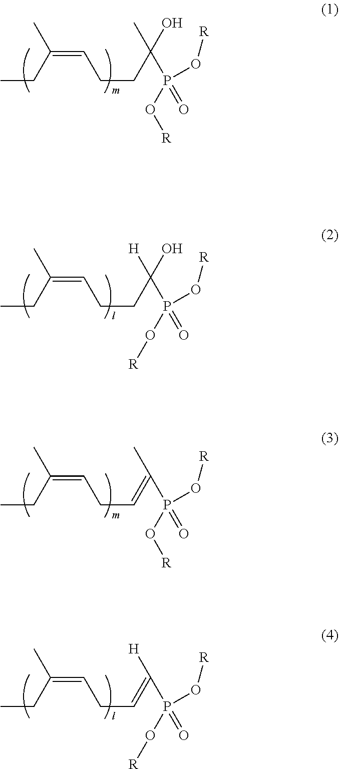

In the formulae (1) to (4), Rs which may be the same or different each represent a hydrogen atom or a hydrocarbon group having 1 to 12 carbon atoms, and m and 1 which may be the same or different, respectively, each represent an integer of 2 or more.

Although not particularly limited, the method for producing an end-modified diene polymer according to the present invention includes an oxidative decomposition step of adding an oxidizing agent to a diene polymer to oxidatively cleave a carbon-carbon double bond, thereby obtaining an oxidatively decomposed diene polymer, and an end modification step of adding phosphites represented by the following formula (5) to the oxidatively decomposed diene polymer obtained and conducting a reaction. The oxidative decomposition step and the end modification step may be conducted in one pot. The term “one pot” used herein means that an end-modified diene polymer is continuously synthesized in one vessel.

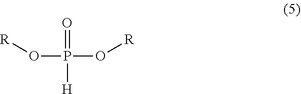

In the formula (5), R represents a hydrogen atom or a hydrocarbon group having 1 to 12 carbon atoms, and two Rs may be the same or different.

Specifically, the end-modified diene polymer according to the present invention is obtained by oxidatively cleaving a carbon-carbon double bond present in a main chain of a diene polymer and reacting a system containing the decomposed polymer with phosphites to modify the end thereof.

The diene polymer to be modified is a polymer containing a structural unit comprising a conjugated diene monomer, and the diene polymer may be a homopolymer of one kind of a conjugated diene monomer, may be a copolymer of two or more kinds of conjugated diene monomers and may be a copolymer of one kind or two or more kinds of conjugated diene monomers and a vinyl monomer. The diene polymer includes natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as a blend of two or more kinds.

The diene polymer to be modified may be liquid at ordinary temperature (23° C.) and may be solid at ordinary temperature (23° C.). The weight average molecular weight of the diene polymer is not particularly limited, and may be 10,000 to 4,000,000, may be 50,000 to 1,000,000 and may be 100,000 to 300,000. In the present specification, the weight average molecular weight is a value obtained by measuring a weight average molecular weight in terms of polystyrene by the measurement with gel permeation chromatography (GPC).

The diene polymer may be any form so long as it is dissolved in a solvent or dispersed in a dispersion medium. An aqueous emulsion in which the diene polymer is present in a micellar form in water that is a protonic dispersion medium, that is, a rubber latex, is preferably used. By using an aqueous emulsion, an end modification reaction can occur by adding phosphites to the decomposed polymer as it is after decomposing the polymer. In other words, the end-modified diene polymer can be continuously synthesized in one vessel. The concentration (solid content concentration of polymer) of the aqueous emulsion is not particularly limited, but is preferably 5 to 70 mass % and more preferably 10 to 50 mass %. When the solid content concentration is too high, emulsion stability is deteriorated. On the other hand, when the solid content concentration is too low, a reaction rate is decreased and this lacks in practicality.

The diene polymer is decomposed by the oxidative cleavage and a polymer having a carbonyl group (>C═O) or a formyl group (—CHO) at the end is obtained. In detail, a polymer having a specific end structure represented by the following formula (A) is formed.

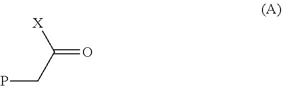

In the formula (A), X is a hydrogen atom or a methyl group, and when an isoprene unit is cleaved, X is a methyl group in one cleaved end and X is a hydrogen atom in another cleaved end. In the formula (A), P represents a polymer chain after the oxidative cleavage.

To oxidatively cleaving a carbon-carbon double bond of the diene polymer, an oxidizing agent can be used. For example, the carbon-carbon double bond can be oxidatively cleaved by adding an oxidizing agent to an aqueous emulsion of the diene polymer, followed by stirring. The oxidizing agent includes a manganese compound such as potassium permanganate or manganese oxide, a chromium compound such as chromic acid or chromium trioxide, a peroxide such as hydrogen peroxide, a perhalogen acid such as periodic acid, and oxygens such as ozone or oxygen. Of those, periodic acid is preferably used. In the oxidative cleavage, a metal-based oxidation catalyst such as a chloride of a metal such as cobalt, copper or iron, or a salt or a complex of the metal with an organic compound may be used together with the oxidizing agent. For example, the diene polymer may be subjected to air oxidation in the presence of the metal-based oxidation catalyst.

By decomposing the polymer by the oxidative cleavage, the molecular weight of the polymer is decreased. The average molecular weight of the polymer after decomposition is not particularly limited, but is preferably 5,000 to 3,000,000 and more preferably 300,000 to 2,000,000.

After decomposing the polymer as above, the reaction system containing the decomposed polymer is reacted with the phosphites. After the reaction, the aqueous emulsion is coagulated and dried, and an end-modified diene polymer that is solid at ordinary temperature (23° C.) is obtained. The end-modified diene polymer obtained has any end structure of the above formulae (1) to (4).

Specifically, by the nucleophilic addition reaction of the phosphites to a carbonyl group or a formyl group in the structure of the formula (A), the end structure represented by the formula (1) or (2) is formed, and when a dehydration reaction further occurs, the end structure represented by the formula (3) or (4) is formed.

The weight average molecular weight of the modified diene polymer is not particularly limited, but is preferably 400,000 to 4,000,000 and more preferably 600,000 to 3,000,000.

According to the present invention, the oxidative cleavage reaction can be controlled by adjusting the kind and amount of the oxidizing agent that is an agent for dissociating a double bond, the reaction time and the like. The molecular weight of the end-modified diene polymer can be controlled by this control.

The amount of the oxidizing agent added is not particularly limited, but is preferably 0.1 to 2.0 parts by mass and more preferably 0.2 to 0.6 parts by mass, per 100 parts by mass of the diene polymer (solid content amount).

The amount of the phosphites added is not particularly limited, but is preferably 0.05 to 1.0 mol and more preferably 0.1 to 0.5 mol, per 1 kg of the diene polymer (solid content amount).

By decomposing the polymer main chain, reacting with phosphites and introducing a phosphate group into the end as in the present invention, pseudo-crosslinking is formed. In other words, by physically bonding by the interaction (Van der Waals binding, hydrogen bond or the like) of phosphate groups introduced into the ends to each other or between a phosphate group and a carbonyl group or a formyl group formed by the oxidative cleavage of the polymer, the end phosphate group acts as a pseudo-crosslinking point. By that pseudo-crosslinking is formed, extension crystallization is accelerated and the improvement effect in mechanical properties is obtained.

Using the end-modified diene polymer according to the present invention, a rubber composition can be produced according to the conventional method.

A diene rubber other than the end-modified diene polymer may be contained as a rubber component in the rubber composition, and the kind thereof is not particularly limited. The diene rubber includes natural rubber (NR), isoprene rubber (IR), butadiene rubber (BR), styrene-butadiene rubber (SBR), styrene-isoprene copolymer rubber, butadiene-isoprene copolymer rubber and styrene-isoprene-butadiene copolymer rubber. Those diene rubbers can be used in one kind alone or as a blend of two or more kinds.

The content of the end-modified diene polymer in the rubber composition is not particularly limited, but is preferably 10 to 100 parts by mass, more preferably 30 to 100 parts by mass and still more preferably 50 to 100 parts by mass, per 100 parts by mass of the rubber component.

In the rubber composition, reinforcing filler such as carbon black or silica can be used as inorganic filler. Specifically, the inorganic filler may be carbon black alone, may be silica alone, and may be a combination of carbon black and silica. A combination of carbon black and silica is preferred. The content of the inorganic filler is not particularly limited. For example, the content is preferably 1 to 150 parts by mass, more preferably 1 to 100 parts by mass and still more preferably 1 to 80 parts by mass, per 100 parts by mass of the rubber component.

The carbon black is not particularly limited, and conventional various kinds can be used. The content of the carbon black is preferably 1 to 70 parts by mass and more preferably 1 to 30 parts by mass, per 100 parts by mass of the rubber component.

The silica is not particularly limited, but wet silica such as wet precipitated silica or wet gelled silica is preferably used. The content of the silica is preferably 1 to 150 parts by mass, more preferably 1 to 100 parts by mass and still more preferably 1 to 80 parts by mass, per 100 parts by mass of the rubber component from the standpoints of the balance of tan 8 of the rubber, reinforcing properties and the like.

In the case of containing silica, a silane coupling agent such as sulfide silane or mercaptosilane may be further contained. In the case of containing the silane coupling agent, the content of the silane coupling agent is preferably 2 to 20 parts by mass per 100 parts by mass of the silica.

In addition to the components described above, additives such as a process oil, zinc flower, stearic acid, a softener, a plasticizer, a wax and an age resister, and vulcanization compounding ingredients such as a vulcanizing agent and a vulcanization accelerator which are usually used in a rubber industry can be appropriately added in the usual range to the rubber composition.

The vulcanizing agent includes sulfur components such as powdered sulfur, precipitated sulfur, colloidal sulfur, insoluble sulfur and highly dispersible sulfur. The content of the vulcanizing agent is preferably 0.1 to 10 parts by mass and more preferably 0.5 to 5 parts by mass, per 100 parts by mass of the rubber component. The content of the vulcanization accelerator is preferably 0.1 to 7 parts by mass and more preferably 0.5 to 5 parts by mass, per 100 parts by mass of the rubber component.

The rubber composition can be prepared using a mixing machine generally used, such as Banbury mixer, a kneader or rolls.

The rubber composition obtained can be used for tires, and can be applied to each site of a tire, such as a tread part or a sidewall part of pneumatic tires for passenger cars and pneumatic tires of various uses and various sizes, such as large-sized tires for trucks or buses. The rubber composition is molded into a predetermined shape by, for example, extrusion according to the conventional method. After combining with other parts, the resulting assembly is vulcanization-molded at a temperature of, for example, 140 to 180° C. Thus, a pneumatic tire can be manufactured.

The kind of the pneumatic tire is not particularly limited, and includes various tires such as tires for passenger cars and heavy load tires used in trucks, buses and the like.

### EXAMPLES

Examples of the present invention are described below, but the present invention is not construed as being limited to those examples.

### Comparative Example 1: Synthesis of Oxidatively Decomposed Diene Polymer

### Oxidative Decomposition Step

200 g of IR latex having a solid content concentration (DRC: Dry Rubber Content) adjusted to 30 mass % was prepared, sodium dodecyl sulfate (2.0 g) was added to the IR latex, and the resulting mixture was stirred for 1 hour in nitrogen atmosphere. Thereafter, tert-butyl hydroperoxide (1.08 mL) and tetraethylene pentaamine (1.3 mL) were added to the mixture, followed by stirring at 60° C. for 3 hours. The reaction solution obtained was added dropwise to acetone and a rubber component was coagulated. The rubber component obtained was washed with water and dried at 50° C. under reduced pressure. Thus, an oxidatively decomposed diene polymer was obtained. The oxidatively decomposed diene polymer obtained had a weight average molecular weight of 6.20×10⁵. It was confirmed from the molecular weight that a chain scission reaction proceeded.

### Examples 1 to 5: Synthesis of End-Modified Diene Polymers 1 to 5

### End-Modifying Step

Diethyl phosphite in an amount (g) shown in Table 1 and 1.1 equivalents of diazabicycloundecene to the diethyl phosphite were added dropwise to an oxidatively decomposed diene polymer prepared in the same manner as in Comparative Example 1, and the resulting mixture was stirred for a reaction time shown in Table 1. The reaction solution obtained was added dropwise to acetone, and a rubber component was coagulated. The rubber component obtained was washed with water and dried at 50° C. under reduced pressure. Thus, end-modified diene polymers 1 to 5 were obtained. It was confirmed from NMR spectra (³¹P-NMR(CDCl₃), δ=5.4 ppm (br), 4.4 ppm(br)) of the end-modified diene polymers that a phosphite group was introduced into the polymer.

### Examples 6 to 8: Synthesis of End-Modified Diene Polymers 6 to 8

### End-Modifying Step

Diphenyl phosphite in an amount (g) shown in Table 1 and 1.1 equivalents of diazabicycloundecene to the diphenyl phosphite were added dropwise to an oxidatively decomposed diene polymer prepared in the same manner as in Comparative Example 1, and the resulting mixture was stirred for a reaction time shown in Table 1. The reaction solution obtained was added dropwise to acetone, and a rubber component was coagulated. The rubber component obtained was washed with water and dried at 50° C. under reduced pressure. Thus, end-modified diene polymers 6 to 8 were obtained. It was confirmed from NMR specta (³¹P-NMR(CDCl₃), δ=2.3 ppm (br)) of the end-modified diene polymers that a phosphite group was introduced into the polymer.

The details of each component described in the examples are as follows.

IR latex: “Califlex IR0401 SU Latex” manufactured by KRATON POLYMER JAPAN, weight average molecular weight=2,530,000

Sodium dodecyl sulfate: Manufactured by FUJIFILM Wako Pure Chemical Corporation

Tert-butyl hydroperoxide: Manufactured by Tokyo Chemical Industry Co., Ltd.

Tetraethyene pentaamine: Manufactured by Tokyo Chemical Industry Co., Ltd.

Diethyl phosphite: Manufactured by Tokyo Chemical Industry Co., Ltd.

Diphenyl phosphite: Manufactured by Tokyo Chemical Industry Co., Ltd.

Diazabicycloundecene: Manufactured by Tokyo Chemical Industry Co., Ltd.

Acetone: Manufactured by Nacalai Tesque, Inc.

TABLE 1

| | Comparative | | | | | | | | |
|---|---|---|---|---|---|---|---|---|---|
| | Example | Example | | | | | | | |
| | 1 | 1 | 2 | 3 | 4 | 5 | 6 | 7 | 8 |
| Isoprene rubber (g) | 60 | 60 | 60 | 60 | 60 | 60 | 60 | 60 | 60 |
| Diethyl phosphite (g) | — | 0.93 | 1.87 | 2.80 | 1.87 | 2.80 | — | — | — |
| Diphenyl phosphite (g) | — | — | — | — | — | — | 1.59 | 3.17 | 3.17 |
| Amount of phosphite | 0 | 0.11 | 0.23 | 0.34 | 0.23 | 0.34 | 0.11 | 0.23 | 0.23 |
| reagent added | | | | | | | | | |
| (mol/kg rubber) | | | | | | | | | |
| Reaction time (hr) | 0 | 3 | 3 | 3 | 18 | 18 | 3 | 3 | 18 |

NMR measurement results and weight average molecular weights of the polymers obtained in Comparative Example 1 and Examples 1 to 8 are shown in Table 2. Each measurement method is as follows.

NMR Measurement Method

Measured by “400 ULTRASHIELD™ PLUS” manufactured by BLUKER. Measurement sample was dissolved in deuterated chloroform and used. Peak intensity was calculated from ³¹P-NMR quantitative spectrum. In the system in which R in the phosphites represented by the formula (5) is ethyl, the total value of peaks of 5.4 ppm and 4.4 ppm was used, and in the system in which R is phenyl, peak value of 2.3 ppm was used.

Weight Average Molecular Weight (Mw)

By the measurement with gel permeation chromatography (GPC), Mn, Mw and Mw/Mn in terms of polystyrene were obtained. In detail, the measurement sample was dissolved in 1 mL of THF and used. Using “LC-20DA” manufactured by Shimadzu Corporation, the sample was permeated through a filter, passed through a column (Shodex KL-806) at a temperature of 40° C. in a flow rate of 1.0 mL/min, and detected by a differential bend detector (RI).

TABLE 2

| | Peak intensity | Molecular weight |
|---|---|---|
| | (INDEX) | (×10⁵) |
| Comparative | 0 | 6.20 |
| Example 1 | | |
| Example 1 | 100 | 11.1 |
| Example 2 | 234 | 11.6 |
| Example 3 | 291 | 9.38 |
| Example 4 | 313 | 7.44 |
| Example 5 | 284 | 8.04 |
| Example 6 | 240 | 12.5 |
| Example 7 | 247 | 11.5 |
| Example 8 | 334 | 11.4 |

It is understood from the comparison in peak intensities of Examples 1 to 3 that the amount of a phosphate group introduced is increased by increasing the amount of a phosphite reagent added.

It is understood from the comparison between Example 2 and Example 4 and the comparison between Example 7 and Example 8 that the amount of a phosphate group introduced is increased by increasing the reaction time.

In the comparison between Example 3 and Example 5, the amount of a phosphate group introduced is not increased even by increasing the reaction time. It can be presumed that this is due to that the vicinity of 300 of peak intensity (INDEX) is the limit of the amount of a phosphate introduced in the conditions of Example 3 and Example 5.

From the comparison between Comparative Example 1 and Examples 1 to 8, the molecular weight of Examples 1 to 8 is increased. It is suggested from this fact that phosphate groups introduced into the ends interact with each other or the phosphate group interacts with a carbonyl group or formyl group formed by the oxidative cleavage of the polymer (Van der Waals binding or hydrogen bond).

Using the polymers of Comparative Example 1 and Examples 1, 2, 4 and 6 to 8, rubber compositions having the following formulations were prepared and vulcanized at 150° C. for 25 minutes, and tensile stress of the rubber compositions after vulcanization was evaluated by the following method.

Formulations

Rubber: 100 parts by mass

Carbon black: 3 parts by mass

Zinc flower: 5 parts by mass

Stearic acid: 2 parts by mass

Sulfur: 2.25 parts by mass

Vulcanization accelerator: 1.1 parts by mass

The details of each component described in the above formulations are as follows.

Rubber: Polymers obtained in Comparative Example 1 and Examples 1, 2, 4 and 6 to 8 Carbon black: “N339 SEAST KH” manufactured by Tokai Carbon Co., Ltd.

Zinc flower: “Zinc Flower #1” manufactured by Mitsui Mining & Smelting Co., Ltd.

Stearic acid: “LUNAC S-20” manufactured by Kao Corporation Sulfur: “Powdered Sulfur for Rubber 150 meshes” manufactured by Hosoi Chemical Industry Co., Ltd.

Vulcanization accelerator: “NOCCELER CZ” manufactured by Ouchi Shinko Chemical Industrial Co., Ltd.

Tensile stress (MPa) at 200% elongation of each of the rubber compositions prepared using the polymers of Comparative Example 1 and Examples 1, 2, 4, 6, 7 and 8 was evaluated. The evaluation method is as follows.

Tensile stress (MPa) at 200% elongation

Tensile test (Dumbbell-shaped 3) was conducted according to JIS K6251, and tensile stress (MPa) at 200% elongation at 25° C. was measured and indicated by an index as the value of Comparative Example 1 being 100. The tensile strength is high and good as the index is large.

TABLE 3

| | Tensile stress at 200% |
|---|---|
| | elongation (INDEX) |
| Comparative | 100 |
| Example 1 | |
| Example 1 | 128 |
| Example 2 | 122 |
| Example 4 | 111 |
| Example 6 | 117 |
| Example 7 | 122 |
| Example 8 | 111 |

The results obtained are shown in Table 3 above. Tensile strength superior to Comparative Example 1 was obtained in all of the Examples shown in Table 3. It is suggested from the results that by the introduction of a phosphate group, phosphate groups introduced into the ends interact with each other or the phosphate group interacts with a carbonyl group or formyl group formed by the oxidative cleavage of the polymer (Van der Waals binding or hydrogen bond).

The rubber composition using the end-modified diene polymer according to the present invention can be used in various tires of passenger cars, light trucks, buses and the like.

What is claimed is:

1. An end-modified diene polymer having at least one of the structures represented by the following formulae (1) to (4) at the end thereof: 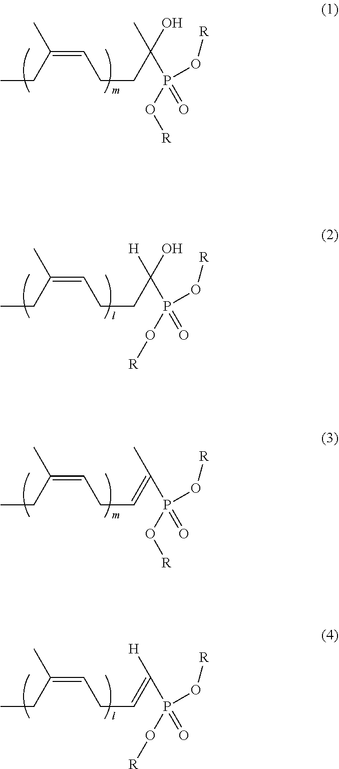
wherein Rs which may be the same or different each represent a hydrogen atom or a hydrocarbon group having 1 to 12 carbon atoms, and m and 1 which may be the same or different, respectively, each represent an integer of 2 or more.

2. The end-modified diene polymer according to claim 1, having a weight average molecular weight of 400,000 to 4,000,000.

3. A method for producing an end-modified diene polymer, which includes:
an oxidative decomposition step of adding an oxidizing agent to a diene polymer to oxidatively cleave a carbon-carbon double bond, thereby obtaining an oxidatively decomposed diene polymer, and
an end modification step of adding phosphites represented by the following formula (5) to the oxidatively decomposed diene polymer obtained and conducting a reaction: 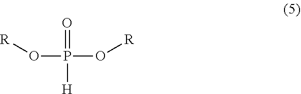
wherein R represents a hydrogen atom or a hydrocarbon group having 1 to 12 carbon atoms, and two Rs may be the same or different.

4. The method for producing an end-modified diene polymer according to claim 3, wherein the amount of the phosphites added is 0.05 to 1.0 mol per 1 kg of the diene polymer.

5. The method for producing an end-modified diene polymer according to claim 3, wherein the diene polymer is used in the form of a rubber latex.

6. The method for producing an end-modified diene polymer according to claim 4, wherein the diene polymer is used in the form of a rubber latex.

7. The method for producing an end-modified diene polymer according to claim 3, wherein the oxidative decomposition step and the end modification step are conducted in one pot.

8. The method for producing an end-modified diene polymer according to claim 4, wherein the oxidative decomposition step and the end modification step are conducted in one pot.

9. The method for producing an end-modified diene polymer according to claim 5, wherein the oxidative decomposition step and the end modification step are conducted in one pot.

10. The method for producing an end-modified diene polymer according to claim 6, wherein the oxidative decomposition step and the end modification step are conducted in one pot.
